(19) United States
(12) Patent Application Publication
(10) Pub. No.: US 2026/0212150 A1
(43) Pub. Date: Jul. 23, 2026

(54) PORTABLE TERMINAL SUPPORTING SHORT-RANGE COMMUNICATION FROM TOP AND BACK THEREOF

(71) Applicant: AMOTECH CO., LTD., Incheon (KR)

(72) Inventors: Seonghyun KIM, Incheon (KR); Jinwon NOH, Incheon (KR); Indeuk YUN, Incheon (KR); Chungha BACK, Incheon (KR); Jungwon SUK, Incheon (KR); Jooseung MAENG, Incheon (KR); Donghyun IM, Incheon (KR); Kisang LIM, Incheon (KR)

(73) Assignee: AMOTECH CO., LTD., Incheon (KR)

(21) Appl. No.: 19/136,722

(22) PCT Filed: Dec. 6, 2023
(86) PCT No.: PCT/KR2023/019947

§ 371 Date: Jun. 6, 2025

(30) Foreign Application Priority Data
Dec. 7, 2022 (KR) 10-2022-0169251
Jan. 3, 2023 (KR) 10-2023-0000489
Nov. 6, 2023 (KR) 10-2023-0151369

(51) Int. Cl. G06K 19/077; H01Q 1/24; H01Q 1/48; H01Q 7/00; H01Q 9/06

(52) U.S. Cl. CPC G06K 19/0775; H01Q 1/243; H01Q 1/48; H01Q 7/00; H01Q 9/06

(57) ABSTRACT

The present disclosure relates to a portable terminal that connects a single ended antenna and a loop antenna to a communication chipset to enable short-range communication from the top and back of the portable terminal, thereby improving the recognition range and distance for short-range communication. The portable terminal having the top and the back comprises: a communication chipset having a first transmitting end and a second transmitting end; a first antenna having a first end connected to a first transmitting end and a second end connected to a second transmitting end; a second antenna having an area arranged parallel to the top of the portable terminal; and a matching module disposed between the first antenna and the second antenna and connected to the first antenna and the second antenna.

### TECHNICAL FIELD

Embodiments of the present disclosure relate to a portable terminal that performs electronic payment, data transmission and reception, and the like through short-range communication.

### BACKGROUND ART

Recently, the demand for electronic payment that pays for goods and services by using a portable terminal is increasing.

Electronic payment on portable terminals is performed using a magnetic secure transmission (MST) method and a near field communication (NFC) method supported by Apple.

The MST method is an electronic payment method of wirelessly transmitting credit card information to make a payment. The MST method has the advantage of being able to use a magnetic payment terminal used for payment using a credit card as it is.

The NFC method is an electronic payment method of making a payment through short-range wireless communication between portable terminals. The NFC method has the advantage that a portable terminal can play a role of existing credit card and payment terminal.

In a portable terminal according to the related art, since an antenna for electronic payment is mounted on the back (i.e., back direction of the portable terminal) of a board, payment can be made only from the back of the portable terminal, so that a user feels inconvenienced.

Therefore, manufacturing companies are developing portable terminals that enable electronic payment from the back and side by disposing an antenna in the direction of one side (i.e., upper side) of the portable terminal.

The contents described in the Background Art are to help the understanding of the background of the disclosure, and may include contents that are not a disclosed related art.

### DISCLOSURE

### Technical Problem

The present disclosure has been proposed in consideration of the aforementioned circumstances, and an object of the present disclosure is to provide a portable terminal that enables short-range communication from the top and back thereof by connecting a single ended antenna and a loop antenna to a communication chipset.

### Technical Solution

In order to achieve the above-described object, a portable terminal according to an embodiment of the present disclosure is a portable terminal including a top and a back and includes: a communication chipset including a first transmitter and a second transmitter; a first antenna including a first end connected to the first transmitter and a second end connected to the second transmitter; a second antenna including an area disposed parallel to the top of the portable terminal; and a matching module disposed between the first antenna and the second antenna and connected to the first antenna and the second antenna.

The second antenna may be configured as a single ended antenna, and a second end of the second antenna may be connected to a ground. The second antenna may include the area parallel to the top of the portable terminal between a first end and a second end of the second antenna.

The second antenna may be configured as a conductor having a bending, and may include: a first conductor including a first end connected to the matching module and disposed to face one of a left side end and a right side end of the portable terminal; and a second conductor including a first end connected to a second end of the first conductor and a second end connected to a ground, and disposed to face the top of the portable terminal.

The second antenna may be configured as a conductor having a bending, and may include: a first conductor including a first end connected to the matching module and disposed to face a left side end of the portable terminal; a second conductor including a first end connected to a second end of the first conductor and disposed to face the top of the portable terminal; and a third conductor including a first end connected to a second end of the second conductor and a second end connected to a ground, and disposed to face a right side end of the portable terminal.

The matching module may be configured as a Balun chip disposed between the first antenna and the second antenna, and the Balun chip may include: a first input/output terminal connected to the first transmitter and the first end of the first antenna; a second input/output terminal connected to the second transmitter and the second end of the first antenna; a third input/output terminal connected to a first end of the second antenna; and a fourth input/output terminal connected to a ground.

The matching module may include: a first inductor connected in parallel to a first line that connects the first antenna and the second antenna and including a first end connected to the first line and a second end connected to a ground; a first capacitor connected in series to the first line and disposed between the first inductor and the second antenna; a second capacitor connected in parallel to a second line that connects the first antenna and the second antenna and including a first end connected to the second line and a second end connected to the ground; and a second inductor connected in series to the second line and disposed between the second capacitor and the second antenna.

The portable terminal according to an embodiment of the present disclosure may further include a matching circuit disposed between the first antenna and the matching module, wherein the matching circuit may be configured to operate as an impedance and resonance frequency matching circuit of the second antenna. The matching circuit may include: a third capacitor connected in series to a third line that connects the first antenna and the matching module; a fourth capacitor including a first end connected to an area of the third line where the third capacitor and the matching module are connected, and a second end connected to a ground; a fifth capacitor connected in series to a fourth line that connects the first antenna and the matching module; and a sixth capacitor including a first end connected to an area of the fourth line where the fifth capacitor and the matching module are connected, and a second end connected to the ground.

The matching circuit may include a first inductor connected in series to a line that connects the first transmitter and the second antenna, and a first matching circuit disposed between the first antenna and the second antenna.

The portable terminal according to an embodiment of the present disclosure may further include a first connection pad connected to the first transmitter and the first end of the first antenna, wherein the first inductor may be disposed on a first line that connects the first connection pad and the first end of the second antenna and connected in series to the first line.

The first matching circuit may further include a first capacitor disposed between the first connection pad and the first inductor and connected in parallel to the first line. A first end of the first capacitor may be connected to the first line, and a second end of the first capacitor may be connected to a ground.

The portable terminal according to an embodiment of the present disclosure may further include a third antenna including an area disposed parallel to the top of the portable terminal and connected to the second transmitter; and a second matching circuit including a second inductor connected in series to a line that connects the second transmitter and the third antenna, and disposed between the first antenna and the third antenna.

The portable terminal according to an embodiment of the present disclosure may further include a second connection pad connected to the second transmitter and the second end of the first antenna, wherein the second inductor is disposed on a second line that connects the second connection pad and a first end of the third antenna and connected in series to the second line. The second matching circuit may further include a second capacitor disposed between the second connection pad and the second inductor and connected in parallel to the second line. A first end of the second capacitor may be connected to the second line, and a second end of the second capacitor may be connected to a ground.

The matching module may include an inductor connected in series to a line that connects the second transmitter and the second antenna, and a matching circuit disposed between the first antenna and the second antenna.

The portable terminal according to an embodiment of the present disclosure may further include a connection pad connected to the second transmitter and the second end of the first antenna, wherein the inductor is disposed on a line that connects the connection pad and the second end of the second antenna and connected in series to the line. The matching circuit may further include a capacitor disposed between the connection pad and the inductor and connected in parallel to the line.

### Advantageous Effects

According to the present disclosure, a portable terminal includes a loop-shaped first antenna parallel to a back thereof and a second antenna configured to be parallel to the top thereof, and improves the recognition range and distance for short-range communication, thereby enabling short-range communication through the top and back of the portable terminal.

In addition, the portable terminal configures an antenna module for short-range communication with a loop antenna and a single ended antenna and has a smaller area than an antenna module including two loop antennas, thereby improving the space utilization.

In addition, the portable terminal configures an antenna module for short-range communication with a loop antenna and a single ended antenna, thereby increasing the recognition range and distance for short-range communication compared to an antenna module including two loop antennas.

### DESCRIPTION OF DRAWINGS

FIGS. 1 and 2 are diagrams for explaining a portable terminal according to a first embodiment of the present disclosure.

FIG. 3 is a diagram for explaining an example of a matching transformer in FIG. 2.

FIG. 4 is a diagram for explaining another example of a matching transformer in FIG. 2.

FIG. 5 is a diagram for explaining a second antenna in FIG. 2.

FIG. 6 is a diagram for explaining a modified example of a second antenna in FIG. 2.

FIG. 7 is a diagram illustrating an equivalent circuit of an antenna module illustrated in FIGS. 1 and 2.

FIGS. 8 and 9 are diagrams for explaining a modified example of an antenna module illustrated in FIGS. 1 and 2.

FIG. 10 is a diagram for explaining a comparison between an antenna module in the related art and an antenna module mounted on the portable terminal according to the first embodiment of the present disclosure.

FIGS. 11 and 12 are diagrams for explaining a portable terminal according to a second embodiment of the present disclosure.

FIG. 13 is a diagram for explaining an example of a first matching circuit in FIG. 2.

FIGS. 14 and 15 are diagrams for explaining a portable terminal according to a third embodiment of the present disclosure.

FIG. 16 is a diagram for explaining an example of a first matching circuit in FIG. 15.

FIGS. 17 and 18 are diagrams for explaining a portable terminal according to a fourth embodiment of the present disclosure.

FIG. 19 is a diagram for explaining an example of a first matching circuit in FIG. 18.

### MODE FOR INVENTION

Hereinafter, preferred embodiments of the present disclosure are described in detail with reference to the accompanying drawings.

Embodiments are provided to more fully explain the present disclosure to a person having ordinary knowledge in the art to which the present disclosure pertains. The following embodiments may be modified in various other forms, and the scope of the present disclosure is not limited to the following embodiments. Rather, these embodiments are provided to make the present disclosure more thorough and complete and to fully convey the spirit of the present disclosure.

Terms used in this specification are used to describe a specific embodiment, and are not intended to limit the present disclosure. Furthermore, in this specification, an expression of the singular number may include an expression of the plural number unless clearly defined otherwise in the context. In the description of the embodiments, the up, down, left, and right are described based on the drawings in principle.

The drawings are merely for enabling the spirit of the present disclosure to be understood, and it should not be interpreted that the scope of the present disclosure is limited by the drawings. Furthermore, in the drawings, a relative thickness or length or a relative size may be enlarged for convenience and the clarity of description.

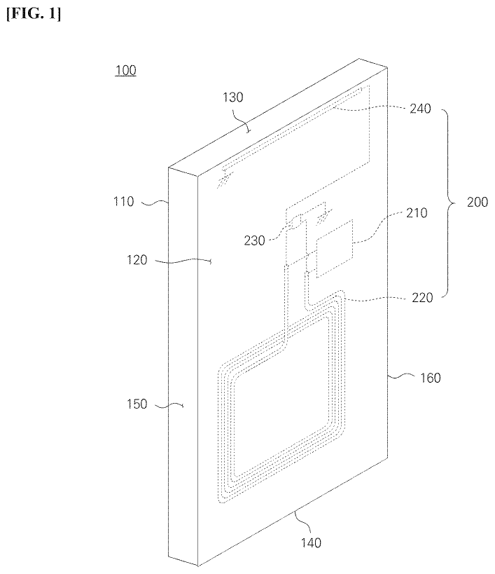

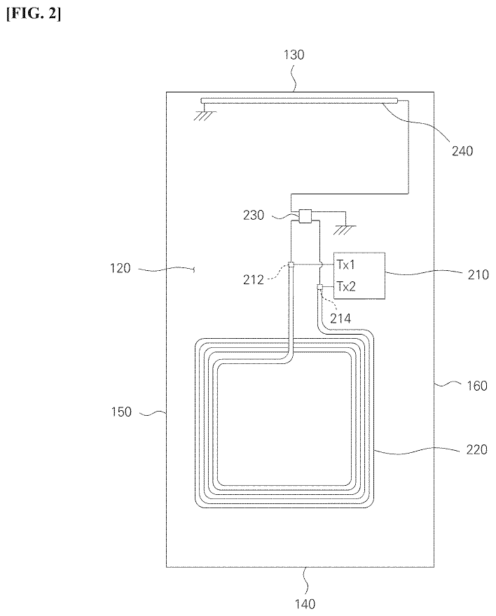

Referring to FIGS. 1 and 2, a portable terminal 100 according to a first embodiment of the present disclosure has a front 110, a back 120, a top 130, a bottom 140, a right side end 150, and a left side end 160. The front 110 is a side on which a display is disposed, and the back 120 is a side on which a cover of the back 120 is disposed.

The portable terminal 100 includes an antenna module 200 that transmits and receives a short-range communication signal. For example, the antenna module 200 is an NFC antenna that transmits and receives payment information through short-range communication with a payment terminal.

The antenna module 200 is disposed so that short-range communication is possible through the back 120 and the top 130 of the portable terminal 100. For example, the antenna module 200 is mounted inside the portable terminal 100, and is disposed between a main board of the portable terminal 100 and the cover of the back 120.

Accordingly, the portable terminal 100 is configured to transmit and receive a short-range communication signal to perform electronic payment in a state in which the top 130 or the back 120 faces the top 130 or the back 120 of another portable terminal 100.

To this end, the antenna module 200 includes a communication chipset 210, a first antenna 220, a matching transformer 230, and a second antenna 240.

The communication chipset 210 is configured as a chipset having a first transmitter TX1 and a second transmitter TX2. For example, the communication chipset 210 is a communication chipset 210 that processes signals in an NFC frequency band.

The first transmitter TX1 of the communication chipset 210 can be connected to a first connection pad 212, and the second transmitter TX2 of the communication chipset 210 can be connected to a second connection pad 214.

The first antenna 220 is an antenna that is configured as a loop antenna and performs short-range communication through the back 120 of the portable terminal 100. For example, the first antenna 220 is a loop antenna that is wound on a plane parallel to the back 120 of the portable terminal 100 to form a loop and is wound on a virtual winding axis that vertically penetrates the front 110 and the back 120 of the portable terminal 100 a plurality of times.

A first end of the first antenna 220 extends outward from an inner peripheral area of the loop and is connected to the first transmitter TX1 of the communication chipset 210. In such a case, the first end of the first antenna 220 can be connected to the first transmitter TX1 of the communication chipset 210 through the first connection pad 212 having a plate shape and connected to the first transmitter TX1 of the communication chipset 210.

A second end of the first antenna 220 is disposed in an outer peripheral area of the loop and is connected to the second transmitter TX2 of the communication chipset 210. In such a case, the second end of the first antenna 220 can be connected to the second transmitter TX2 of the communication chipset 210 through the second connection pad 214 having a plate shape and connected to the second transmitter TX2 of the communication chipset 210.

The matching transformer 230 operates as a transformer that converts a balanced signal into an unbalanced signal. The matching transformer 230 minimizes loss when combining the balanced signal of the first antenna 220 having a differential structure and the unbalanced signal of the second antenna 240.

The matching transformer 230 converts the phase of power (voltage, current) output from the first transmitter TX1 and the second transmitter TX2 of the communication chipset 210 into the same phase and applies the converted power to the second antenna 240. Accordingly, all (100%) of the power output from the first transmitter TX1 and the second transmitter TX2 of the communication chipset 210 is applied to the second antenna 240, and the recognition distance of the second antenna 240 increases.

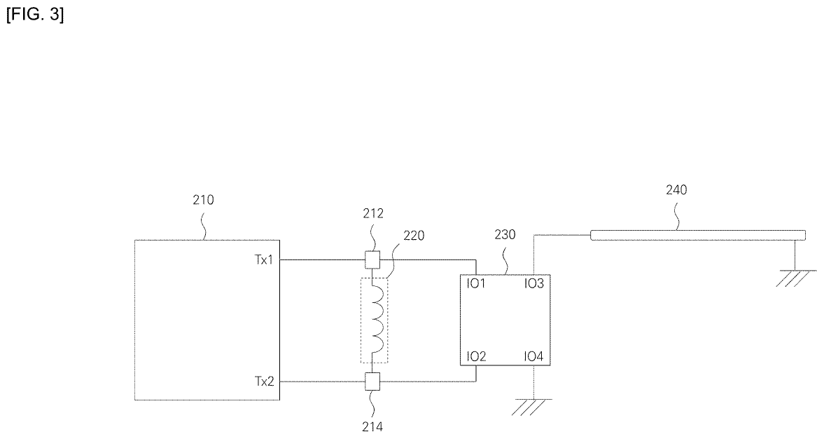

Referring to FIG. 3, for example, the matching transformer 230 is configured as a Balun (BALanced-to-Unbalanced) chip including a first input/output terminal IO1, a second input/output terminal IO2, a third input/output terminal IO3, and a fourth input/output terminal IO4.

The first input/output terminal IO1 is connected to the first transmitter TX1 of the communication chipset 210. In such a case, the first input/output terminal IO1 can be connected to the first transmitter TX1 of the communication chipset 210 through the first connection pad 212 having a plate shape and connected to the first transmitter TX1 of the communication chipset 210.

The second input/output terminal IO2 is connected to the second transmitter TX2 of the communication chipset 210. In such a case, the second input/output terminal IO2 can be connected to the second transmitter TX2 of the communication chipset 210 through the second connection pad 214 having a plate shape and connected to the second transmitter TX2 of the communication chipset 210.

The third input/output terminal IO3 is connected to the second antenna 240. The third input/output terminal IO3 is connected to a first end of the second antenna 240 to form a power supply line of the second antenna 240.

The fourth input/output terminal IO4 is connected to the ground. The fourth input/output terminal IO4 can be connected to a ground GND formed on the main board of the portable terminal 100 or a separately configured ground GND.

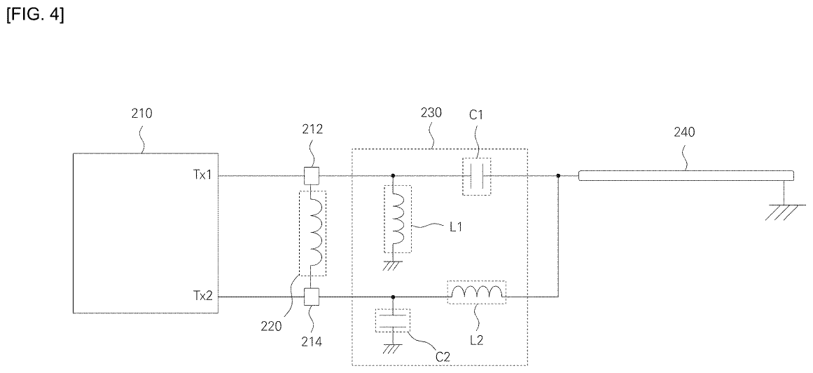

Referring to FIG. 4, the matching transformer 230 may also be configured as an LC circuit including a first inductor L1, a first capacitor C1, a second capacitor C2, and a second inductor L2.

The first inductor L1 is connected in parallel to a first line that connects the first connection pad 212, which is connected to the first transmitter TX1 of the communication chipset 210 and the first end of the first antenna 220, and the second antenna 240. A first end of the first inductor L1 is connected to the first line and a second end of the first inductor L1 is connected to the ground.

The first capacitor C1 is disposed on the first line that connects the first connection pad 212, which is connected to the first transmitter TX1 of the communication chipset 210 and the first end of the first antenna 220, and the second antenna 240. The first capacitor C1 is connected in series on the first line and is disposed between the first inductor L1 and the second antenna 240.

The second capacitor C2 is connected in parallel to a second line that connects the second connection pad 214, which is connected to the second transmitter TX2 of the communication chipset 210 and the second end of the first antenna 220, and the second antenna 240. A first end of the second capacitor C2 is connected to the second line and a second end of the second capacitor C2 is connected to the ground.

The second inductor L2 is disposed on the second line that connects the second connection pad 214, which is connected to the second transmitter TX2 of the communication chipset 210 and the second end of the first antenna 220, and the second antenna 240. The second inductor L2 is connected in series on the second line and is disposed between the second capacitor C2 and the second antenna 240.

The second antenna 240 is configured as a single ended antenna, and operates as a radiator that transmits and receives a short-range communication signal through the top 130 of the portable terminal 100. The second antenna 240 is configured as a conductor and may be configured as an LDS type, an FPCB type, a metal frame, etc.

The first end of the second antenna 240 is connected to the third input/output terminal IO3 of the matching transformer 230. In such a case, the first end of the second antenna 240 is connected to the third input/output terminal IO3 of the matching transformer 230 through a first connection pattern.

A second end of the second antenna 240 is connected to the ground GND. In such a case, the second end of the second antenna 240 can be connected to the ground GND formed on the main board of the portable terminal 100 or the separately configured ground GND.

The second antenna 240 is configured as a conductor parallel to the top 130 of the portable terminal 100. The second antenna 240 is configured as a conductor having a predetermined length and having a plate shape and is disposed adjacent to the top 130 of the portable terminal 100 and parallel to the top 130 of the portable terminal 100.

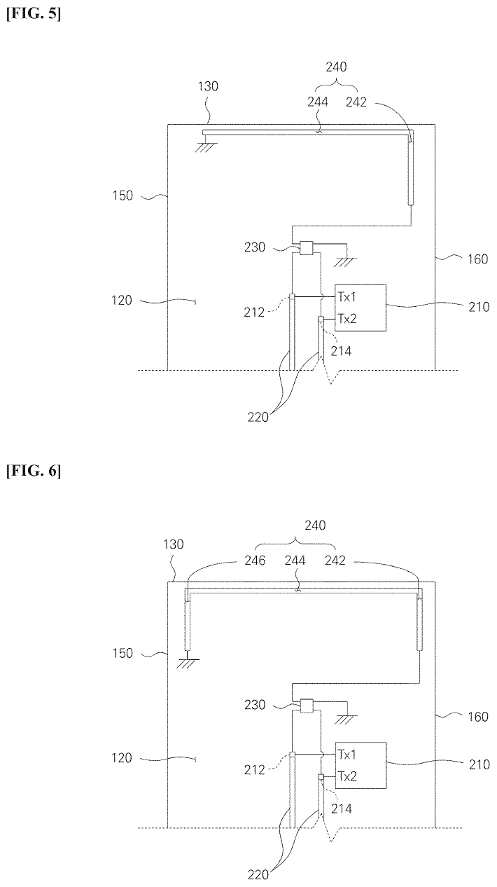

Referring to FIG. 5, the second antenna 240 is configured as a conductor having one bending. For example, the second antenna 240 is formed in a substantially reverse-“L” shape, starting from the third input/output terminal IO3 of the matching transformer 230 and passing through the right side end 150 or left side end 160 of the portable terminal 100 and the top 130 of the portable terminal 100 to be connected to the ground. To this end, the second antenna 240 includes a first conductor 242 and a second conductor 244.

The first conductor 242 is disposed parallel to the left side end 160 (and/or the right side end 150) of the portable terminal 100. A first end of the first conductor 242 is connected to the third input/output terminal IO3 of the matching transformer 230. A second end of the second conductor 244 is connected to a first end of the second conductor 244.

The second conductor 244 is disposed orthogonal to the first conductor 242 and is disposed parallel to the top 130 of the portable terminal 100. The first end of the second conductor 244 is connected to a second end of the first conductor 242, and the second end of the second conductor 244 is connected to the ground GND.

The first conductor 242 and the second conductor 244 may be disposed so that an angle between them forms a predetermined angle. That is, FIG. 5 illustrates that the first conductor 242 and the second conductor 244 are orthogonal; however, the present disclosure is not limited thereto and the first conductor 242 and the second conductor 244 may be configured to have an angle less than 90° or an angle exceeding 90° therebetween.

Referring to FIG. 6, as another example, the second antenna 240 has two bendings, and is formed in a substantially “C” shape, starting from the third input/output terminal IO3 of the matching transformer 230 and passing through the left side end 160 (and/or the right side end 150), the top 130, and the right side end 150 (and/or the left side end 160) of the portable terminal 100 to be connected to the ground.

To this end, the second antenna 240 includes a first conductor 242, a second conductor 244, and a third conductor 246.

The first conductor 242 is disposed parallel to the left side end 160 (and/or the right side end 150) of the portable terminal 100. A first end of the first conductor 242 is connected to the third input/output terminal IO3 of the matching transformer 230. A second end of the second conductor 244 is connected to a first end of the second conductor 244.

The second conductor 244 is disposed orthogonal to the first conductor 242 and is disposed parallel to the top 130 of the portable terminal 100. The first end of the second conductor 244 is connected to the second end of the first conductor 242, and the second end of the second conductor 244 is connected to a first end of the third conductor 246.

The third conductor 246 is disposed parallel to the right side end 150 (and/or the left side end 160) of the portable terminal 100. The first end of the third conductor 246 is connected to the second end of the second conductor 244. The second end of the second conductor 244 is connected to the ground GND.

The first conductor 242, the second conductor 244, and the third conductor 246 may also be disposed so that an angle between the first conductor 242 and the second conductor 244 forms a predetermined angle and an angle between the second conductor 244 and the third conductor 246 forms a predetermined angle. That is, FIG. 6 illustrates that the second conductor 244 is orthogonal to the first conductor 242 and the third conductor 246; however, the present disclosure is not limited thereto and the second conductor 244 and the first conductor 242/the third conductor 246 may be configured to have an angle less than 90° or an angle exceeding 90° therebetween.

The second antenna 240 may be modified into various forms depending on the positions of the communication chipset 210, the first antenna 220, the matching transformer 230, etc. In such a case, the second antenna 240 may be modified into various forms as long as it includes a conductor disposed parallel to the top 130 of the portable terminal 100.

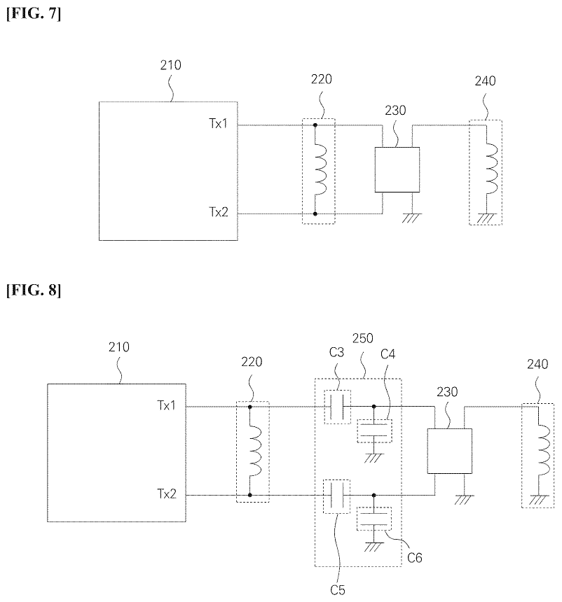

Referring to FIG. 7, the antenna module 200 used in the portable terminal 100 according to the first embodiment of the present disclosure configures a short-range communication module in which the first antenna 220 is connected to the first transmitter TX1 and the second transmitter TX2 of the communication chipset 210 and the second antenna 240 being a single ended antenna is connected to the communication chipset 210 through the matching transformer 230.

The antenna module 200 includes the first antenna 220 being a differential-type antenna and the second antenna 240 being a single ended antenna, and is configured so that the first antenna 220 having a relatively wide radiation area performs short-range communication through the back 120 of the portable terminal 100 and the second antenna 240 having a relatively narrow radiation area performs short-range communication through the top 130 (and a part of both side ends) of the portable terminal 100.

Accordingly, the portable terminal 100 according to the first embodiment of the present disclosure can increase a short-range communication recognition range. In particular, the portable terminal 100 according to the first embodiment of the present disclosure can increase a short-range communication recognition range of the top 130 while improving space utilization by disposing the second antenna 240 being a single ended antenna at the top 130.

Referring to FIG. 8, the antenna module 200 may further include a first matching circuit 250 connected between the first antenna 220 and the second antenna 240 in order to optimize the performance of the second antenna 240.

The first matching circuit 250 is connected between the first antenna 220 and the second antenna 240 and operates as an impedance and resonance frequency matching circuit of the second antenna 240. In such a case, the first matching circuit 250 may also operate as an impedance and resonance frequency matching circuit of the first antenna 220 and the second antenna 240.

The first matching circuit 250 is formed on a third line that connects the first end of the first antenna 220 (i.e., the first transmitter TX1 of the communication chipset 210) and the first input/output terminal IO1 of the matching transformer 230 and a fourth line that connects the second end of the first antenna 220 (i.e., the second transmitter TX2 of the communication chipset 210) and the second input/output terminal IO2 of the matching transformer 230.

For example, the first matching circuit 250 includes a third capacitor C3 and a fourth capacitor C4 connected to the third line, and a fifth capacitor C5 and a sixth capacitor C6 connected to the fourth line.

The third capacitor C3 is connected in series to the third line on the third line.

A first end of the fourth capacitor C4 is connected to the third line. A second end of the fourth capacitor C4 is connected to the ground. In such a case, the first end of the fourth capacitor C4 is connected to an area of the third line where the third capacitor C3 and the matching transformer 230 are connected.

The fifth capacitor C5 is connected in series to the fourth line on the fourth line.

A first end of the sixth capacitor C6 is connected to the fourth line, and a second end of the sixth capacitor C6 is connected to the ground. In such a case, the first end of the sixth capacitor C6 is connected to an area of the fourth line where the fifth capacitor C5 and the matching transformer 230 are connected.

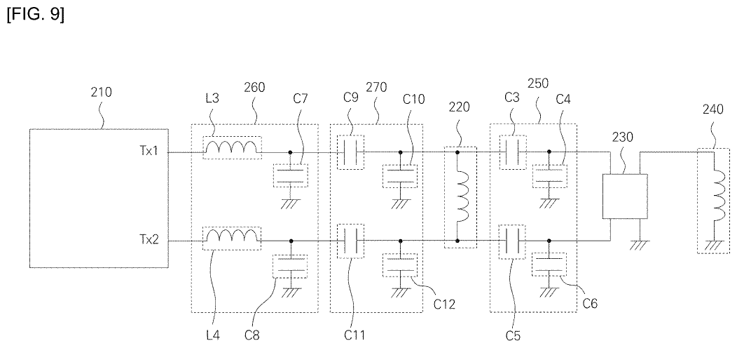

Referring to FIG. 9, the antenna module 200 may further include a filter circuit 260 and a second matching circuit 270.

The filter circuit 260 includes an inductor and a capacitor, and is connected to the communication chipset 210 and the first antenna 220 to operate as an electromagnetic shielding (i.e., EMC, EMI) filter. The filter circuit 260 is formed on the first line that connects the first transmitter TX1 of the communication chipset 210 and the first end of the first antenna 220, and the second line that connects the second transmitter TX2 of the communication chipset 210 and the second end of the first antenna 220.

For example, the filter circuit 260 includes a third inductor L3 and a seventh capacitor C7 connected to the first line, and a fourth inductor L4 and an eighth capacitor C8 connected to the second line.

The third inductor L3 is disposed on the first line and is connected in series to the first line.

A first end of the seventh capacitor C7 is connected to the first line, and the second end of the seventh capacitor C7 is connected to the ground. In such a case, the first end of the seventh capacitor C7 is connected to an area of the first line where the third inductor L3 and the second matching circuit 270 are connected.

The fourth inductor L4 is connected in series to the second line.

A first end of the eighth capacitor C8 is connected to the second line, and the second end of the eighth capacitor C8 is connected to the ground. In such a case, the first end of the eighth capacitor C8 is connected to an area of the second line where the fourth inductor L4 and the second matching circuit 270 are connected.

The second matching circuit 270 includes a plurality of capacitors, and is connected between the filter circuit 260 and the first antenna 220 to operate as an impedance and resonance frequency matching circuit of the first antenna 220.

For example, the second matching circuit 270 includes a ninth capacitor C9 and a tenth capacitor C10 connected to the first line, an eleventh capacitor C11 and a twelfth capacitor C12 connected to the second line.

The ninth capacitor C9 is connected in series to the first line on the first line.

A first end of the tenth capacitor C10 is connected to the first line, and a second end of the tenth capacitor C10 is connected to ground. In such a case, the first end of the tenth capacitor C10 is connected to an area of the first line where the ninth capacitor C9 and the first antenna 220 are connected.

The eleventh capacitor C11 is connected in series to the second line on the second line.

A first end of the twelfth capacitor C12 is connected to the second line, and a second end of the twelfth capacitor C12 is connected to the ground. In such a case, the first end of the twelfth capacitor C12 is connected to an area of the second line where the eleventh capacitor C11 and the first antenna 220 are connected.

The filter circuit 260 and the second matching circuit 270 are circuits specified (required) by the manufacturer of the communication chipset 210, and the circuit configuration may vary depending on the communication chipset 210.

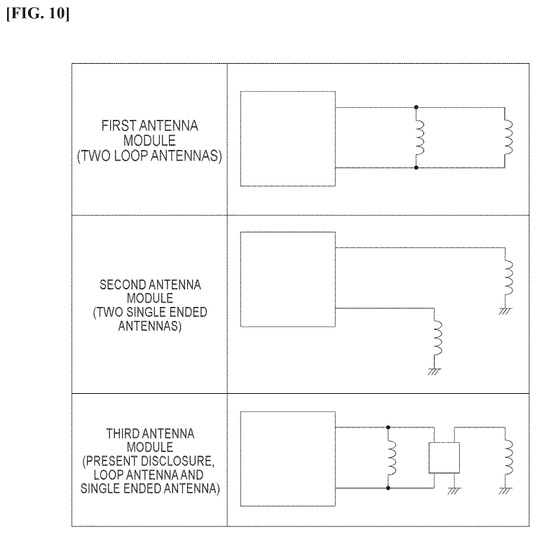

Referring to FIG. 10, the portable terminal 100 may be configured with a first antenna module including two loop antennas, a second antenna module including two single ended antennas, and a third antenna module including one loop antenna and one single ended antenna.

The first antenna module includes the two loop antennas and thus has a wide radiation area.

Since the two loop antennas of the first antenna module share power output from the first transmitter TX1 and the second transmitter TX2 of the communication chipset 210, power interference occurs and the level of the power applied to the two loop antennas decreases.

Accordingly, in the first antenna module, the recognition range for short-range communication increases, but the recognition distance decreases.

The second antenna module includes the two single ended antennas and thus has a relatively narrower radiation area than the first antenna module.

Since the power output from the first transmitter TX1 and the second transmitter TX2 of the communication chipset 210 is applied to each of the two single ended antennas of the second antenna module, the level of the power does not decrease.

Accordingly, in the second antenna module, the recognition range for short-range communication decreases compared to the first antenna module, but the recognition distance increases.

The third antenna module is the antenna module 200 mounted on the portable terminal 100 according to the first embodiment of the present disclosure, and includes one loop antenna and one single ended antenna.

The third antenna module has a narrower radiation area than the first antenna module, but a wider radiation area than the second antenna module. In particular, the third antenna module has a wide radiation area on the back 120 of the portable terminal 100.

In the third antenna module, the loop antenna and the single ended antenna share the power output from the first transmitter TX1 and the second transmitter TX2 of the communication chipset 210, but the matching transformer 230 compensates for the power applied to the single ended antenna.

Accordingly, the third antenna module has the effect of increasing the recognition range and distance compared to the first antenna module and the second antenna module.

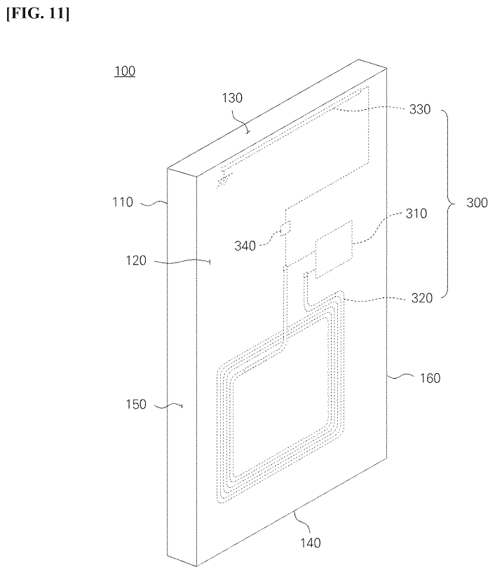

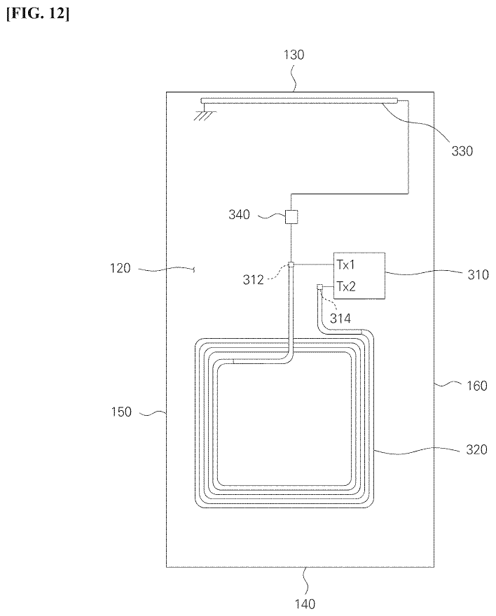

Referring to FIGS. 11 and 12, a portable terminal 100 according to a second embodiment of the present disclosure has the front 110, the back 120, the top 130, the bottom 140, the right side end 150, and the left side end 160. The front 110 is a side on which a display is disposed, and the back 120 is a side on which a cover of the back 120 is disposed.

The portable terminal 100 includes an antenna module 300 that transmits and receives a short-range communication signal. For example, the antenna module 300 is an NFC antenna that transmits and receives payment information through short-range communication with a payment terminal.

The antenna module 300 is disposed so that short-range communication is possible through the back 120 and the top 130 of the portable terminal 100. For example, the antenna module 300 is mounted inside the portable terminal 100, and is disposed between a main board of the portable terminal 100 and the cover of the back 120.

Accordingly, the portable terminal 100 is configured to transmit and receive a short-range communication signal to perform electronic payment in a state in which the top 130 or the back 120 faces the top 130 or the back 120 of another portable terminal 100.

To this end, the antenna module 300 includes a communication chipset 310, a first antenna 320, a second antenna 330, and a first matching circuit 340.

The communication chipset 310 is configured as a chipset having a first transmitter TX1 and a second transmitter TX2. For example, the communication chipset 310 is a communication chipset 310 that processes signals in an NFC frequency band.

The first transmitter TX1 of the communication chipset 310 can be connected to a first connection pad 312, and the second transmitter TX2 of the communication chipset 310 can be connected to a second connection pad 314.

The first antenna 320 is an antenna that is configured as a loop antenna and performs short-range communication through the back 120 of the portable terminal 100. For example, the first antenna 320 is a loop antenna that is wound on a plane parallel to the back 120 of the portable terminal 100 to form a loop and is wound on a virtual winding axis that vertically penetrates the front 110 and the back 120 of the portable terminal 100 a plurality of times.

A first end of the first antenna 320 extends outward from an inner peripheral area of the loop and is connected to the first transmitter TX1 of the communication chipset 310. In such a case, the first end of the first antenna 320 can be connected to the first transmitter TX1 of the communication chipset 310 through the first connection pad 312 having a plate shape and connected to the first transmitter TX1 of the communication chipset 310.

A second end of the first antenna 320 is disposed in an outer peripheral area of the loop and is connected to the second transmitter TX2 of the communication chipset 310. In such a case, the second end of the first antenna 320 can be connected to the second transmitter TX2 of the communication chipset 310 through the second connection pad 314 having a plate shape and connected to the second transmitter TX2 of the communication chipset 310.

The second antenna 330 is configured as a single ended antenna, and operates as a radiator that transmits and receives a short-range communication signal through the top 130 of the portable terminal 100. The second antenna 330 is configured as a conductor and may be configured as an LDS type, an FPCB type, a metal frame, etc.

The second antenna 330 is configured as a conductor parallel to the top 130 of the portable terminal 100. The second antenna 330 is configured as a conductor having a predetermined length and having a plate shape and is disposed adjacent to the top 130 of the portable terminal 100 and parallel to the top 130 of the portable terminal 100.

The second antenna 330 may be modified into various forms depending on the positions of the communication chipset 310, the first antenna 320, the first matching circuit 340, etc. In such a case, the second antenna 330 may be modified into various forms as long as it includes a conductor disposed parallel to the top 130 of the portable terminal 100.

A first end of the second antenna 330 is connected to the first matching circuit 340. In such a case, the first end of the second antenna 330 is connected to an output terminal of the first matching circuit 340 through a connection pad.

A second end of the second antenna 330 is connected to a ground GND. In such a case, the second end of the second antenna 330 may be connected to a ground GND formed on a main board of the portable terminal 100 or a separately configured ground GND.

The second antenna 330 is connected to the first transmitter TX1 of the communication chipset 310 and is connected in parallel to the first antenna 320. In such a case, the second antenna 330 can be regarded as a one-turn inductor, and the one-turn inductor has very low inductance. Since the second antenna 330 has very low inductance, it resonates at a very high frequency and is not able to be matched with the first antenna 320, resulting in a state where it can receive no signal.

The first matching circuit 340 is a circuit for impedance matching of the first antenna 320 and the second antenna 330. That is, the first matching circuit 340 increases the inductance of the second antenna 330 through an inductor connected in series to the second antenna 330, thereby enabling matching of the first antenna 320 and the second antenna 330.

In other words, the first matching circuit 340 increases the inductance of the second antenna 330 to a level equivalent to the inductance of the first antenna 320 by connecting an inductor having a very large inductance in series with the second antenna 330. Accordingly, the second antenna 330 is matched with the first antenna 320 and is in a state where it can receive a signal.

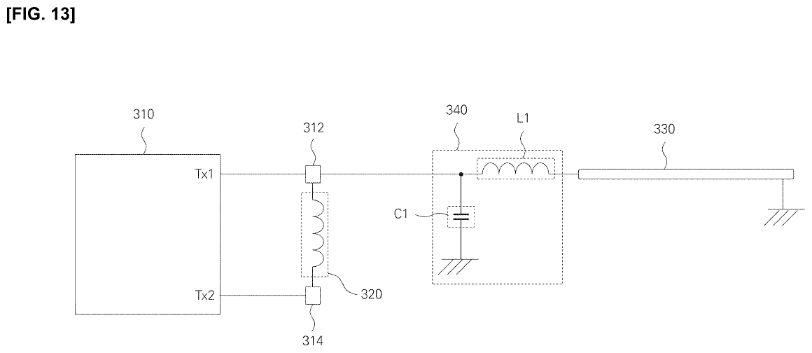

Referring to FIG. 13, the first matching circuit 340 includes a first inductor L1 and a first capacitor C1.

The first inductor L1 is connected to a first line that connects the first connection pad 312 and the second antenna 330. The first inductor L1 is connected in series on the first line and is disposed between the first connection pad 312 and the second antenna 330. A first end of the first inductor L1 is connected to the first connection pad 312, and a second end of the first inductor L1 is connected to the first end of the second antenna 330. The first connection pad 312 is connected to the first transmitter TX1 of the communication chipset 310 and the first end of the first antenna 320.

The first inductor L1 is connected in series to the second antenna 330 to compensate for the inductance of the second antenna 330. Accordingly, the first inductor L1 may be configured as a chip inductor, a coil inductor, etc., and any member capable of compensating the inductance of the second antenna 330 may be used.

The first capacitor C1 is connected to the first line that connects the first connection pad 312 and the second antenna 330. The first capacitor C1 is connected in parallel on the first line and is disposed between the first connection pad 312 and the first inductor L1.

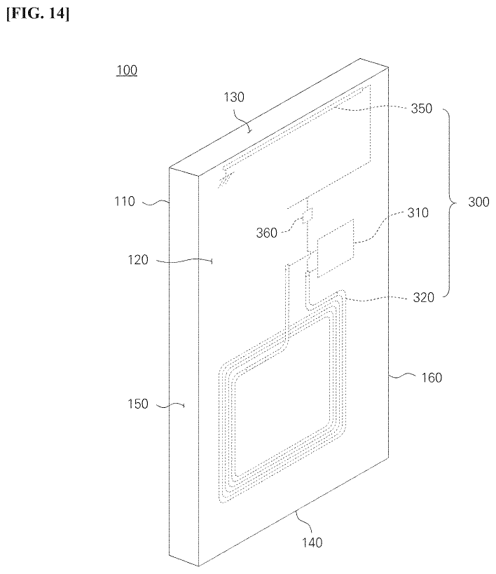

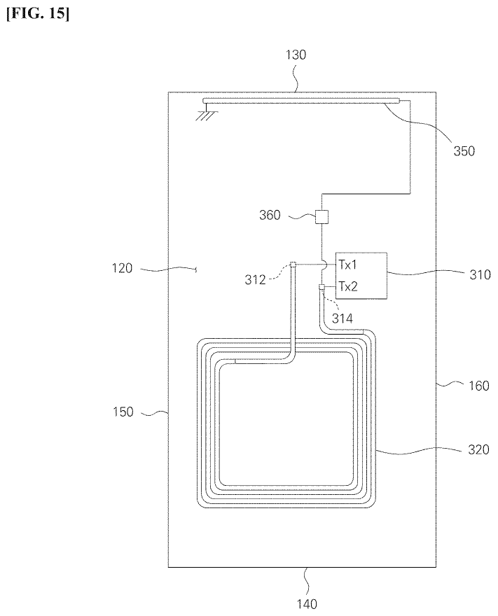

Referring to FIGS. 14 and 15, an antenna module 300 of a portable terminal 100 according to a third embodiment of the present disclosure includes a communication chipset 310, a first antenna 320, a third antenna 350, and a second matching circuit 360.

The communication chipset 310 is configured as a chipset having a first transmitter TX1 and a second transmitter TX2. For example, the communication chipset 310 is a communication chipset 310 that processes signals in an NFC frequency band.

The first transmitter TX1 of the communication chipset 310 can be connected to a first connection pad 312, and the second transmitter TX2 of the communication chipset 310 can be connected to a second connection pad 314.

The first antenna 320 is an antenna that is configured as a loop antenna and performs short-range communication through the back 120 of the portable terminal 100. For example, the first antenna 320 is a loop antenna that is wound on a plane parallel to the back 120 of the portable terminal 100 to form a loop and is wound on a virtual winding axis that vertically penetrates the front 110 and the back 120 of the portable terminal 100 a plurality of times.

A first end of the first antenna 320 extends outward from an inner peripheral area of the loop and is connected to the first transmitter TX1 of the communication chipset 310. In such a case, the first end of the first antenna 320 can be connected to the first transmitter TX1 of the communication chipset 310 through the first connection pad 312 having a plate shape and connected to the first transmitter TX1 of the communication chipset 310.

A second end of the first antenna 320 is disposed in an outer peripheral area of the loop and is connected to the second transmitter TX2 of the communication chipset 310. In such a case, the second end of the first antenna 320 can be connected to the second transmitter TX2 of the communication chipset 310 through the second connection pad 314 having a plate shape and connected to the second transmitter TX2 of the communication chipset 310.

The third antenna 350 is configured as a single ended antenna, and operates as a radiator that transmits and receives a short-range communication signal through the top 130 of the portable terminal 100. The third antenna 350 is configured as a conductor and may be configured as an LDS type, an FPCB type, a metal frame, etc.

The third antenna 350 is configured as a conductor parallel to the top 130 of the portable terminal 100. The third antenna 350 is configured as a conductor having a predetermined length and having a plate shape and is disposed adjacent to the top 130 of the portable terminal 100 and parallel to the top 130 of the portable terminal 100.

The third antenna 350 may be modified into various forms depending on the positions of the communication chipset 310, the first antenna 320, the second matching circuit 360, etc. In such a case, the third antenna 350 may be modified into various forms as long as it includes a conductor disposed parallel to the top 130 of the portable terminal 100.

A first end of the third antenna 350 is connected to the second matching circuit 360. In such a case, the first end of the third antenna 350 is connected to an output terminal of the second matching circuit 360 through a connection pad.

A second end of the third antenna 350 is connected to a ground GND. In such a case, the second end of the third antenna 350 may be connected to a ground GND formed on a main board of the portable terminal 100 or a separately configured ground GND.

The third antenna 350 is connected to the second transmitter TX2 of the communication chipset 310 and is connected in parallel to the first antenna 320. In such a case, the third antenna 350 can be regarded as a one-turn inductor, and the one-turn inductor has very low inductance. Since the third antenna 350 has very low inductance, it resonates at a very high frequency and is not able to be matched with the first antenna 320, resulting in a state where it can receive no signal.

The second matching circuit 360 is a circuit for impedance matching of the first antenna 320 and the third antenna 350. That is, the second matching circuit 360 increases the inductance of the third antenna 350 through an inductor connected in series to the third antenna 350, thereby enabling matching of the first antenna 320 and the third antenna 350.

In other words, the second matching circuit 360 increases the inductance of the third antenna 350 to a level equivalent to the inductance of the first antenna 320 by connecting an inductor having a very large inductance in series with the third antenna 350. Accordingly, the third antenna 350 is matched with the first antenna 320 and is in a state where it can receive a signal.

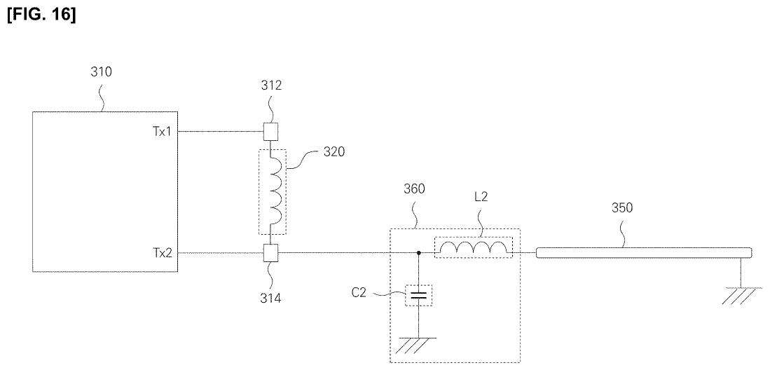

Referring to FIG. 16, the second matching circuit 360 includes a second inductor L2 and a second capacitor C2.

The second inductor L2 is connected to a second line that connects the second connection pad 314 and the third antenna 350. The second inductor L2 is connected in series on the second line and is disposed between the second connection pad 314 and the third antenna 350. A first end of the second inductor L2 is connected to the second connection pad 314, and a second end of the second inductor L2 is connected to the first end of the third antenna 350. The second connection pad 314 is connected to the second transmitter TX2 of the communication chipset 310 and the first end of the first antenna 320.

The second inductor L2 is connected in series to the third antenna 350 to compensate for the inductance of the third antenna 350. Accordingly, the second inductor L2 may be configured as a chip inductor, a coil inductor, etc., and any member capable of compensating the inductance of the third antenna 350 may be used.

The second capacitor C2 is connected to the second line that connects the second connection pad 314 and the third antenna 350. The second capacitor C2 is connected in parallel on the second line and is disposed between the second connection pad 314 and the second inductor L2.

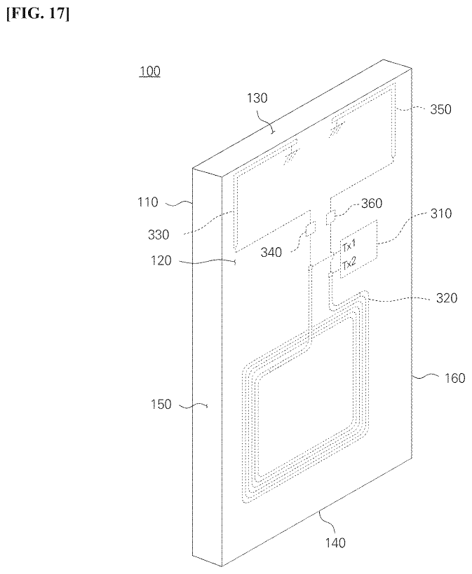

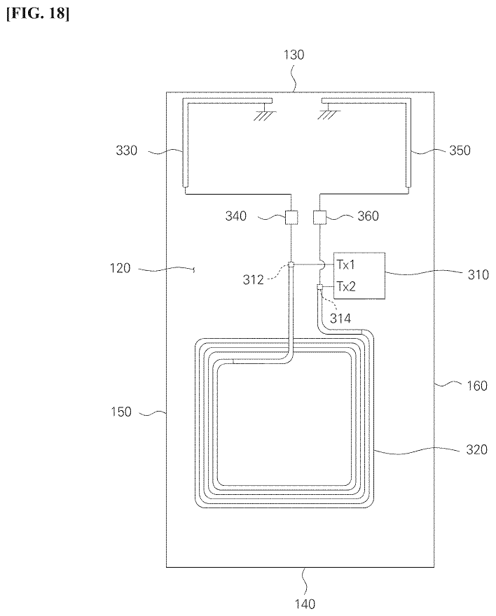

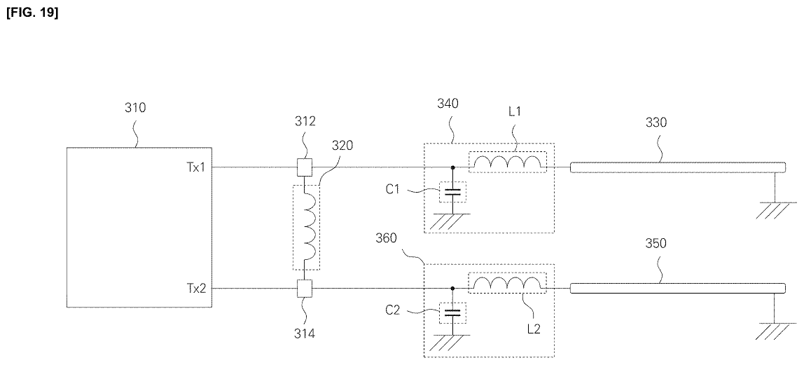

Referring to FIGS. 17 and 18, an antenna module 300 of a portable terminal 100 according to a fourth embodiment of the present disclosure includes a communication chipset 310, a first antenna 320, a second antenna 330, a first matching circuit 340, a third antenna 350, and a second matching circuit 360.

The communication chipset 310 is configured as a chipset having a first transmitter TX1 and a second transmitter TX2. For example, the communication chipset 310 is a communication chipset 310 that processes signals in an NFC frequency band.

The first transmitter TX1 of the communication chipset 310 can be connected to a first connection pad 312, and the second transmitter TX2 of the communication chipset 310 can be connected to a second connection pad 314.

The first antenna 320 is an antenna that is configured as a loop antenna and performs short-range communication through the back 120 of the portable terminal 100. For example, the first antenna 320 is a loop antenna that is wound on a plane parallel to the back 120 of the portable terminal 100 to form a loop and is wound on a virtual winding axis that vertically penetrates the front 110 and the back 120 of the portable terminal 100 a plurality of times.

A first end of the first antenna 320 extends outward from an inner peripheral area of the loop and is connected to the first transmitter TX1 of the communication chipset 310. In such a case, the first end of the first antenna 320 can be connected to the first transmitter TX1 of the communication chipset 310 through the first connection pad 312 having a plate shape and connected to the first transmitter TX1 of the communication chipset 310.

A second end of the first antenna 320 is disposed in an outer peripheral area of the loop and is connected to the second transmitter TX2 of the communication chipset 310. In such a case, the second end of the first antenna 320 can be connected to the second transmitter TX2 of the communication chipset 310 through the second connection pad 314 having a plate shape and connected to the second transmitter TX2 of the communication chipset 310.

The second antenna 330 is configured as a single ended antenna, and operates as a radiator that transmits and receives a short-range communication signal through the top 130 of the portable terminal 100. The second antenna 330 is configured as a conductor and may be configured as an LDS type, an FPCB type, a metal frame, etc.

The second antenna 330 is configured as a conductor parallel to the top 130 of the portable terminal 100. The second antenna 330 is configured as a conductor having a predetermined length and having a plate shape and is disposed adjacent to the top 130 of the portable terminal 100 and parallel to the top 130 of the portable terminal 100.

The second antenna 330 may be modified into various forms depending on the positions of the communication chipset 310, the first antenna 320, the first matching circuit 340, etc. In such a case, the second antenna 330 may be modified into various forms as long as it includes a conductor disposed parallel to the top 130 of the portable terminal 100.

A first end of the second antenna 330 is connected to the first matching circuit 340. In such a case, the first end of the second antenna 330 is connected to an output terminal of the first matching circuit 340 through a connection pad.

A second end of the second antenna 330 is connected to a ground GND. In such a case, the second end of the second antenna 330 may be connected to a ground GND formed on a main board of the portable terminal 100 or a separately configured ground GND.

The second antenna 330 is connected to the first transmitter TX1 of the communication chipset 310 and is connected in parallel to the first antenna 320. In such a case, the second antenna 330 can be regarded as a one-turn inductor, and the one-turn inductor has very low inductance. Since the second antenna 330 has very low inductance, it resonates at a very high frequency and is not able to be matched with the first antenna 320, resulting in a state where it can receive no signal.

The first matching circuit 340 is a circuit for impedance matching of the first antenna 320 and the second antenna 330. That is, the first matching circuit 340 increases the inductance of the second antenna 330 through an inductor connected in series to the second antenna 330, thereby enabling matching of the first antenna 320 and the second antenna 330.

In other words, the first matching circuit 340 increases the inductance of the second antenna 330 to a level equivalent to the inductance of the first antenna 320 by connecting an inductor having a very large inductance in series with the second antenna 330. Accordingly, the second antenna 330 is matched with the first antenna 320 and is in a state where it can receive a signal.

Referring to FIG. 19, the first matching circuit 340 includes a first inductor L1 and a first capacitor C1.

The first inductor L1 is connected to a first line that connects the first connection pad 312 and the second antenna 330. The first inductor L1 is connected in series on the first line and is disposed between the first connection pad 312 and the second antenna 330. A first end of the first inductor L1 is connected to the first connection pad 312, and a second end of the first inductor L1 is connected to the first end of the second antenna 330. The first connection pad 312 is connected to the first transmitter TX1 of the communication chipset 310 and the first end of the first antenna 320.

The first inductor L1 is connected in series to the second antenna 330 to compensate for the inductance of the second antenna 330. Accordingly, the first inductor L1 may be configured as a chip inductor, a coil inductor, etc., and any member capable of compensating the inductance of the second antenna 330 may be used.

The first capacitor C1 is connected to the first line that connects the first connection pad 312 and the second antenna 330. The first capacitor C1 is connected in parallel on the first line and is disposed between the first connection pad 312 and the first inductor L1.

The third antenna 350 is configured as a single ended antenna, and operates as a radiator that transmits and receives a short-range communication signal through the top 130 of the portable terminal 100. The third antenna 350 is configured as a conductor and may be configured as an LDS type, an FPCB type, a metal frame, etc.

The third antenna 350 is configured as a conductor parallel to the top 130 of the portable terminal 100. The third antenna 350 is configured as a conductor having a predetermined length and having a plate shape and is disposed adjacent to the top 130 of the portable terminal 100 and parallel to the top 130 of the portable terminal 100.

The third antenna 350 may be modified into various forms depending on the positions of the communication chipset 310, the first antenna 320, the second matching circuit 360, etc. In such a case, the third antenna 350 may be modified into various forms as long as it includes a conductor disposed parallel to the top 130 of the portable terminal 100.

A first end of the third antenna 350 is connected to the second matching circuit 360. In such a case, the first end of the third antenna 350 is connected to an output terminal of the second matching circuit 360 through a connection pad.

A second end of the third antenna 350 is connected to a ground GND. In such a case, the second end of the third antenna 350 may be connected to a ground GND formed on a main board of the portable terminal 100 or a separately configured ground GND.

The third antenna 350 is connected to the second transmitter TX2 of the communication chipset 310 and is connected in parallel to the first antenna 320. In such a case, the third antenna 350 can be regarded as a one-turn inductor, and the one-turn inductor has very low inductance. Since the third antenna 350 has very low inductance, it resonates at a very high frequency and is not able to be matched with the first antenna 320, resulting in a state where it can receive no signal.

The second matching circuit 360 is a circuit for impedance matching of the first antenna 320 and the third antenna 350. That is, the second matching circuit 360 increases the inductance of the third antenna 350 through an inductor connected in series to the third antenna 350, thereby enabling matching of the first antenna 320 and the third antenna 350.

In other words, the second matching circuit 360 increases the inductance of the third antenna 350 to a level equivalent to the inductance of the first antenna 320 by connecting an inductor having a very large inductance in series with the third antenna 350. Accordingly, the third antenna 350 is matched with the first antenna 320 and is in a state where it can receive a signal.

Referring to FIG. 19, the second matching circuit 360 includes a second inductor L2 and a second capacitor C2.

The second inductor L2 is connected to a second line that connects the second connection pad 314 and the third antenna 350. The second inductor L2 is connected in series on the second line and is disposed between the second connection pad 314 and the third antenna 350. A first end of the second inductor L2 is connected to the second connection pad 314, and a second end of the second inductor L2 is connected to the first end of the third antenna 350. The second connection pad 314 is connected to the second transmitter TX2 of the communication chipset 310 and the first end of the first antenna 320.

The second inductor L2 is connected in series to the third antenna 350 to compensate for the inductance of the third antenna 350. Accordingly, the second inductor L2 may be configured as a chip inductor, a coil inductor, etc., and any member capable of compensating the inductance of the third antenna 350 may be used.

The second capacitor C2 is connected to the second line that connects the second connection pad 314 and the third antenna 350. The second capacitor C2 is connected in parallel on the second line and is disposed between the second connection pad 314 and the second inductor L2.

The above description is merely a description of the technical spirit of the present disclosure, and those skilled in the art may change and modify the present disclosure in various ways without departing from the essential characteristic of the present disclosure. Accordingly, the embodiments described in the present disclosure should not be construed as limiting the technical spirit of the present disclosure, but should be construed as describing the technical spirit of the present disclosure. The technical spirit of the present disclosure is not restricted by the embodiments. The range of protection of the present disclosure should be construed based on the following claims, and all technical spirits falling within the equivalent range thereto should be construed as being included in the scope of rights of the present disclosure. cm 1. A portable terminal including a top and a back, the portable terminal comprising:
a communication chipset including a first transmitter and a second transmitter;
a first antenna including a first end connected to the first transmitter and a second end connected to the second transmitter;
a second antenna including an area disposed parallel to the top of the portable terminal; and
a matching module disposed between the first antenna and the second antenna and connected to the first antenna and the second antenna.

2. The portable terminal of claim 1, wherein the second antenna is configured as a single ended antenna, and
a second end of the second antenna is connected to a ground.

3. The portable terminal of claim 1, wherein the second antenna includes the area parallel to the top of the portable terminal between a first end and a second end of the second antenna.

4. The portable terminal of claim 1, wherein the second antenna is configured as a conductor having a bending, and comprises:
a first conductor including a first end connected to the matching module and disposed to face one of a left side end and a right side end of the portable terminal; and
a second conductor including a first end connected to a second end of the first conductor and a second end connected to a ground, and disposed to face the top of the portable terminal.

5. The portable terminal of claim 1, wherein the second antenna is configured as a conductor having a bending, and comprises:
a first conductor including a first end connected to the matching module and disposed to face a left side end of the portable terminal;
a second conductor including a first end connected to a second end of the first conductor and disposed to face the top of the portable terminal; and
a third conductor including a first end connected to a second end of the second conductor and a second end connected to a ground, and disposed to face a right side end of the portable terminal.

6. The portable terminal of claim 1, wherein the matching module is configured as a Balun chip disposed between the first antenna and the second antenna, and
the Balun chip comprises:
a first input/output terminal connected to the first transmitter and the first end of the first antenna;
a second input/output terminal connected to the second transmitter and the second end of the first antenna;
a third input/output terminal connected to a first end of the second antenna; and
a fourth input/output terminal connected to a ground.

7. The portable terminal of claim 1, wherein the matching module comprises:
a first inductor connected in parallel to a first line that connects the first antenna and the second antenna and including a first end connected to the first line and a second end connected to a ground;
a first capacitor connected in series to the first line and disposed between the first inductor and the second antenna;
a second capacitor connected in parallel to a second line that connects the first antenna and the second antenna and including a first end connected to the second line and a second end connected to the ground; and
a second inductor connected in series to the second line and disposed between the second capacitor and the second antenna.

8. The portable terminal of claim 1, further comprising:
a matching circuit disposed between the first antenna and the matching module,
wherein the matching circuit is configured to operate as an impedance and resonance frequency matching circuit of the second antenna.

9. The portable terminal of claim 8, wherein the matching circuit comprises:
a third capacitor connected in series to a third line that connects the first antenna and the matching module;
a fourth capacitor including a first end connected to an area of the third line where the third capacitor and the matching module are connected, and a second end connected to a ground;
a fifth capacitor connected in series to a fourth line that connects the first antenna and the matching module; and
a sixth capacitor including a first end connected to an area of the fourth line where the fifth capacitor and the matching module are connected, and a second end connected to the ground.

10. The portable terminal of claim 1, wherein the matching module includes a first inductor connected in series to a line that connects the first transmitter and the second antenna, and a first matching circuit disposed between the first antenna and the second antenna.

11. The portable terminal of claim 10, further comprising:
a first connection pad connected to the first transmitter and the first end of the first antenna,
wherein the first inductor is disposed on a first line that connects the first connection pad and the first end of the second antenna and connected in series to the first line.

12. The portable terminal of claim 11, wherein the first matching circuit further comprises:
a first capacitor disposed between the first connection pad and the first inductor and connected in parallel to the first line.

13. The portable terminal of claim 12, wherein a first end of the first capacitor is connected to the first line, and
a second end of the first capacitor is connected to a ground.

14. The portable terminal of claim 10, further comprising:
a third antenna including an area disposed parallel to the top of the portable terminal and connected to the second transmitter; and
a second matching circuit including a second inductor connected in series to a line that connects the second transmitter and the third antenna, and disposed between the first antenna and the third antenna.

15. The portable terminal of claim 14, further comprising:
a second connection pad connected to the second transmitter and the second end of the first antenna,
wherein the second inductor is disposed on a second line that connects the second connection pad and a first end of the third antenna and connected in series to the second line.

16. The portable terminal of claim 15, wherein the second matching circuit further comprises:
a second capacitor disposed between the second connection pad and the second inductor and connected in parallel to the second line.

17. The portable terminal of claim 16, wherein a first end of the second capacitor is connected to the second line, and
a second end of the second capacitor is connected to a ground.

18. The portable terminal of claim 1, wherein the matching module includes an inductor connected in series to a line that connects the second transmitter and the second antenna, and a matching circuit disposed between the first antenna and the second antenna.

19. The portable terminal of claim 18, further comprising:
a connection pad connected to the second transmitter and the second end of the first antenna,
wherein the inductor is disposed on a line that connects the connection pad and the second end of the second antenna and connected in series to the line.

20. The portable terminal of claim 19, wherein the matching circuit further comprises:
a capacitor disposed between the connection pad and the inductor and connected in parallel to the line.
